(19) United States
(12) Patent Application Publication
(10) Pub. No.: US 2026/0116152 A1
(43) Pub. Date: Apr. 30, 2026

(54) Cooling and/or Heating System for a Vehicle and a Method for Operating the System

(71) Applicant: MAHLE International GmbH, Stuttgart (DE)

(72) Inventors: Thomas Strauß (STRAUSS), Notzingen (DE); Sascha Lindauer, Schorndorf (DE); Hans-Ulrich Steurer, Stuttgart (DE)

(21) Appl. No.: 19/370,121

(22) Filed: Oct. 27, 2025

(30) Foreign Application Priority Data
Oct. 29, 2024 (DE) 102024131606.3

(51) Int. Cl. B60H 1/32

(52) U.S. Cl. CPC B60H 1/3228

(57) ABSTRACT

A cooling and/or heating system for a vehicle is provided. The system contains a coolant circuit with two subsidiary circuits. A chiller, a cab cooler, and a bypass are connected to the first subsidiary circuit, and the chiller and a distributor valve are connected to the other subsidiary circuit. The subsidiary circuits are connected to one another upstream of the chiller and separated from one another downstream of the chiller. A method for operating the system is provided.

### CROSS-REFERENCE TO RELATED APPLICATIONS

This application claims priority from German Patent Application No. DE 10 2024 131 606.3, filed on Oct. 29, 2024, the entirety of which is hereby incorporated by reference herein.

The invention relates to a cooling and/or heating system for a vehicle according to the preamble of Numbered Paragraph 1, and a method for operating the system.

The battery for a vehicle and the air flowing into the cab can be cooled by coolant in a coolant circuit in the vehicle. The coolant itself can be cooled in a chiller in a refrigerant circuit. The temperature of the coolant must stay above 0° C. to prevent the cab cooler from icing up due to moisture in the air. The heat absorbed by the cab cooler may not always be enough to heat the cab when in the heat pump mode.

The object of the invention is to therefore create a better, or at least different, design for this type of system, with which these disadvantages are resolved. It is also the object of the invention to create a method for operating this system.

These problems are solved with the invention by the subject matter of the independent Numbered Paragraphs. Advantageous embodiments are the subject matter of the dependent Numbered Paragraphs.

The system obtained with the invention, i.e. a thermal management system, is intended or designed for cooling and/or heating a vehicle. The system contains a chiller, a cab cooler through which the air flowing into the cab in the vehicle flows, and a distributor valve. The distributor valve can be a unit that contains numerous valves. The chiller is connected to a refrigerant circuit in the system through which refrigerant flows. The cab cooler, chiller and distributor valve are connected to a coolant circuit in the system through which coolant flows. The coolant circuit has a first subsidiary circuit to which the chiller and cab cooler are connected, and a second subsidiary circuit, to which the chiller and distributor valve are connected. The distributor valve can connect the coolant circuit to other components in the system. The first and second subsidiary circuits split up at a separating point in the coolant circuit and rejoin at a connecting point. The circuit separating point is downstream of the chiller and upstream of the cab cooler and the distributor valve. The circuit connecting point is upstream of the chiller and downstream of the cab cooler and the distributor valve. The system also has a bypass. The bypass is connected to the first subsidiary circuit at a connecting point and a separating point. The bypass connecting point is downstream of the circuit separating point, and upstream of the cab cooler. The bypass separating point is downstream of the cab cooler and upstream of the circuit connecting point.

The coolant in the first subsidiary circuit can be returned to the first subsidiary circuit through the bypass. The coolant flowing through the bypass circumvents the chiller in this case, and is not cooled. The coolant in the second subsidiary circuit can still flow through the chiller and be cooled. Consequently, the coolant in the two subsidiary circuits may be at different temperatures. As a result, the air flowing into the cab can be at a higher temperature than other components that are connected to the second subsidiary circuit, e.g. the low-temperature cooler in the vehicle. Consequently, the temperature of the coolant in the first subsidiary circuit may be above 0° C., thus preventing the cab cooler from icing up, and the cooling of the components connected to the second subsidiary circuit can be kept at or increased to that of the low-temperature cooler.

The system can contain a first pump, which is downstream of the bypass connecting point in the first subsidiary circuit in the coolant circuit, and upstream of the bypass separating point. The first pump can be operated to convey coolant in the first subsidiary circuit, separately from the second subsidiary circuit.

The system can contain a second pump, which is downstream of the circuit separating point in the second subsidiary circuit in the coolant circuit, and upstream of the circuit connecting point. The second pump can be operated to convey coolant in the second subsidiary circuit, separately from the first subsidiary circuit. The second pump could also be downstream of the circuit connection point and upstream of the chiller. In this case, the second pump can convey coolant in the first subsidiary circuit and the second subsidiary circuit.

The system can contain a three-way valve that can be connected to the first subsidiary circuit in the coolant circuit at the bypass separating point. The three-way valve can control the flow of coolant in the first subsidiary circuit and the bypass. Coolant is prevented from flowing through the bypass or allowed to flow through the bypass at the three-way valve. In other words, the three-way valve can open or close the bypass. In particular, the three-way valve can control how much coolant flows through the bypass. This makes it possible to adjust the temperature of the coolant in the first subsidiary circuit by controlling the amount of coolant flowing through the bypass.

The system can contain a low-temperature cooler through which outside air flows. The low-temperature cooler and distributor valve can then be connected to a radiator coolant circuit. The distributor valve can connect the radiator circuit to the second subsidiary circuit in the coolant circuit. Consequently, the coolant can flow successively through the chiller and the low-temperature cooler. In other words, the distributor valve can connect or disconnect the chiller and low-temperature cooler to or from one another, depending on how the system is to be operated.

The system can contain a battery cooler for the vehicle battery. The battery cooler and distributor valve can then be connected to a battery coolant circuit. The distributor valve can connect the battery circuit to the second subsidiary circuit in the coolant circuit. Consequently, coolant can then flow through the chiller and battery cooler successively. In other words, the distributor valve can connect or disconnect the chiller and battery cooler to or from one another, depending on how the system is to be operated.

If the system contains the low-temperature cooler and the battery cooler, the distributor valve can connect or disconnect the battery circuit and/or the radiator circuit to or from the second subsidiary circuit in the coolant circuit—specifically individually. In other words, the distributor valve can connect or disconnect the chiller to or from the battery cooler and/or the low-temperature cooler.

The invention also relates to a method for operating the system described above. This regulates the bypass in the system based on the temperature setting for the coolant in the first subsidiary circuit and/or second subsidiary circuit in the coolant circuit.

The system can contain a first and second pump. The first and second pumps can then convey coolant through the first subsidiary circuit and/or second subsidiary circuit. The system can also contain a low-temperature cooler and a battery cooler. The battery cooler and distributor valve can be connected to a battery coolant circuit, and the low-temperature cooler and distributor valve can be connected to a radiator coolant circuit. The distributor valve can connect and/or disconnect the radiator circuit and/or the battery circuit to or from the second subsidiary circuit in the coolant circuit.

The system can be operated in different modes by changing the settings for the bypass and the distributor valve, and how the first and second pumps are operated. Some of these modes shall be explained in greater detail below.

In a cab-cooling mode, the air in the vehicle cab is cooled. Coolant flows through the first subsidiary circuit in the cab-cooling mode. In this case, no coolant flows through the second subsidiary circuit and the bypass. The bypass can be opened by the three-way valve described above, in which case the first and second pump are then switched on.

The three-way valve can be set in the cab-cooling mode such that the bypass is closed and all of the coolant in the first subsidiary circuit flows from the bypass separating point to the circuit connection point, and from there to the chiller. The coolant flowing through the first subsidiary circuit can then be cooled in the chiller by the refrigerant in the refrigerant circuit, and then cool the air flowing into the cab through the cab cooler. The temperature of the coolant can be between −2° C. and 12° C. as it exits the chiller, and between 2° C. and 15° C. when it exits the cab cooler. The coolant temperature can be set as needed for cooling the cab. Because coolant is not flowing through the second subsidiary circuit, no coolant from the second subsidiary circuit flows through the battery cooler and low-temperature cooler, such that the battery is not cooled by coolant in the second subsidiary circuit. If the second pump in the second subsidiary circuit is downstream of the circuit separating point, and upstream of the circuit connecting point, the second pump remains off. The first pump is on, and pumps the coolant in the first subsidiary circuit. If the second pump is downstream of the circuit connecting point and upstream of the chiller, the first and/or second pumps can be switched on, and pump the coolant in the first subsidiary circuit.

The system can be operated in a battery/cab-cooling mode to cool air in the vehicle cab and the vehicle battery. Coolant flows through the first and second subsidiary circuits in the battery/cab-cooling mode. The battery circuit is connected to the second subsidiary circuit for this, such that coolant flows through it. The radiator circuit is not connected to the second subsidiary circuit in this case, such that no coolant flows through it. No coolant flows through the bypass. The bypass can be connected accordingly by the three-way valve and the distributor valve to operate the first and second pumps as needed.

The three-way valve can be set in the battery/cab-cooling mode such that the bypass is closed and all of the coolant in the first subsidiary circuit flows from the bypass separating point to the circuit connecting point and then to the chiller. Starting at the circuit connecting point, the coolant from the first and second subsidiary circuits can flow together to the chiller. The coolant can then be cooled by the refrigerant in the refrigerant circuit in the chiller, and flow through the first and second subsidiary circuits starting at the circuit separating point. The coolant can then cool the air flowing into the vehicle cab with the cab cooler in the first subsidiary circuit, and cool the vehicle battery with the battery cooler in the second subsidiary circuit. The coolant temperature can be between −2° C. and 12° C. when exiting the chiller, and between 2° C and 15° C. when exiting the cab cooler. The coolant temperature can be set as needed for cooling the cab. Depending on the demands and/or the desired volumetric flow of the coolant in the subsidiary circuits, the first and/or second pumps can be switched on together or separately to pump coolant.

The system can be operated in a cab-heating mode to heat the air flowing into the cab. In this mode, coolant flows through the second subsidiary circuit. The battery circuit is not connected to the second subsidiary circuit in this case, such that no coolant flows through it. The radiator circuit is connected to the second subsidiary circuit instead. Coolant does not flow through the first subsidiary circuit or the bypass in this case. The bypass can be connected accordingly by the three-way valve and the distributor valve, to operate the first and second pumps.

The first pump can be switched off in the cab-heating mode, such that no coolant can flow through the first subsidiary circuit. Consequently, no coolant from the first subsidiary circuit can flow through the cab cooler, such that the air flowing into the cab is not cooled by coolant in the first subsidiary circuit. The air flowing into the cab can then be heated to the desired or necessary temperature by an external heater. The second pump can be switched on to pump coolant in the second subsidiary circuit. the coolant in the second subsidiary circuit can be cooled in the chiller by the refrigerant in the refrigerant circuit, and absorb heat in the low-temperature cooler. The low-temperature cooler is then used as a heat source for a heat pump. The temperature of the coolant can be between −30° C. and 15° C. when exiting the chiller. The coolant temperature can be set on the basis of the demands for controlling the heat pump.

The system can be operated in a dehumidifying mode for dehumidifying the air flowing into the cab. Coolant flows through the first and second subsidiary circuits, as well as the bypass, in the dehumidifying mode. The battery circuit is not connected to the second subsidiary circuit, such that no coolant from the second subsidiary circuit flows through it. The radiator circuit is connected to the second subsidiary circuit instead, such that coolant flows through it. The bypass can be connected accordingly by the three-way valve and distributor valve, to operate the first and second pumps.

At least part of the coolant flowing through the first subsidiary circuit can be returned to it at the bypass separating point through the bypass in the dehumidifying mode. This keeps the temperature of the coolant in the first subsidiary circuit above 0° C.

The three-way valve can be set in the dehumidifying mode such that the coolant from the first subsidiary circuit is returned to it without flowing through the chiller. The amount of coolant returned to the first subsidiary circuit can be set such that it controls or regulates the temperature of the coolant therein. This reliably prevents the cab cooler from icing up. The coolant in the second subsidiary circuit can be cooled by the chiller, such that its temperature is below 0° C. The coolant temperature in the first subsidiary circuit can be between 2° C. and 25° C. The temperature in the second subsidiary circuit can be between −30° C. and 15° C.

The system can be operated in the cab-cooling mode and/or the cab/battery-cooling mode if the outside temperature is between 10° C. and 50° C. The system can be operated in the cab-heating mode if the outside temperature is between −40° C. and 20°C. The system can be operated in the dehumidifying mode if the outside temperature is between 0° C. and 25° C.

In the context of the present invention, the phrase, “flowing through it successively” is synonymous with the phrase, “flowing through it in a series,” or “flowing through it sequentially.” The term, “chiller,” is used synonymously with the term, “evaporator.” The phrase, “connected to a circuit,” is synonymous with the phrase, “attached to a circuit,” or “through which coolant or refrigerant can flow successively in a circuit.” The low-temperature cooler can be an air/liquid heat exchanger, through which outside air and coolant flow without mixing them, such that they exchange heat. The cab cooler can be an air/liquid heat exchanger, through which air flowing into the cab and coolant flow, without mixing them, such that they exchange heat. The chiller can be a liquid/liquid heat exchanger, through which coolant and refrigerant flow, without mixing them, such that they exchange heat. The battery cooler can be a unit through which coolant flows that has numerous channels.

Other important features and advantages of the invention can be derived from the dependent Numbered Paragraphs, drawings, and descriptions of the drawings.

It is understood that the features specified above and explained below can be used not only in the given combinations, but also in other combinations or in and of themselves, without abandoning the scope of the invention.

Preferred exemplary embodiments of the invention are illustrated in the drawings and shall be explained in greater detail below, in which the same reference symbols are used for identical, similar, or functionally identical components.

Therein, schematically:

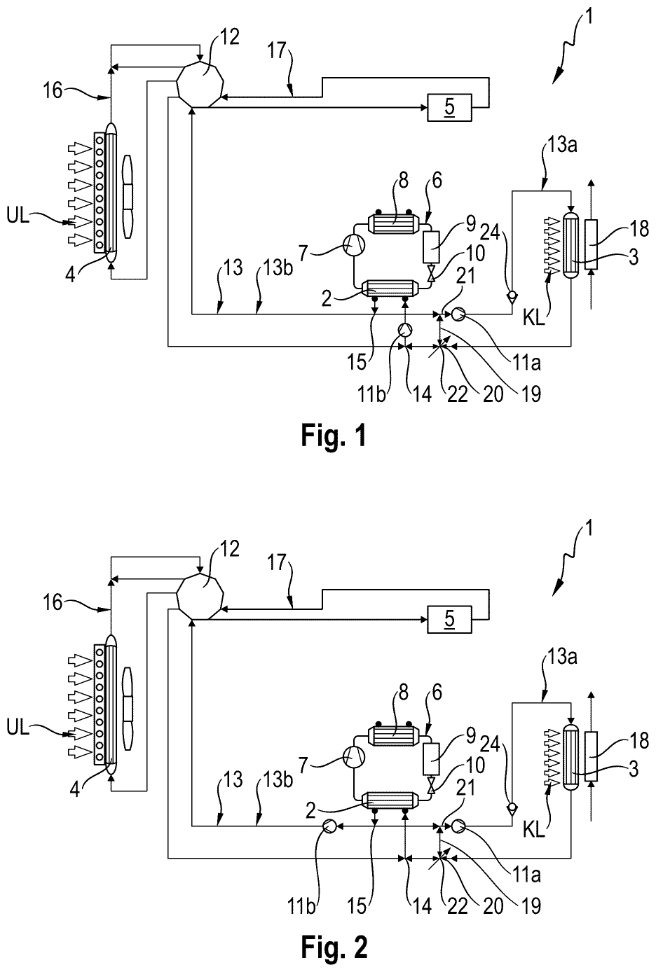

FIG. 1 shows a first embodiment of the system obtained with the invention;

FIG. 2 shows a second embodiment of the system obtained with the invention;

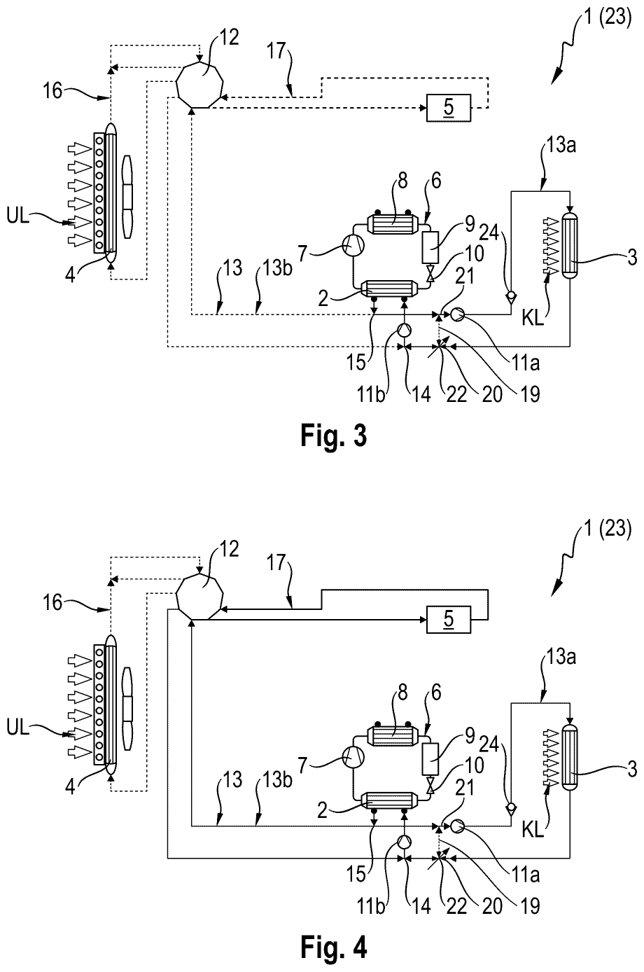

FIG. 3 shows the first embodiment of the system obtained with the invention in the cab-cooling mode;

FIG. 4 shows the first embodiment of the system obtained with the invention in the cab/battery-cooling mode;

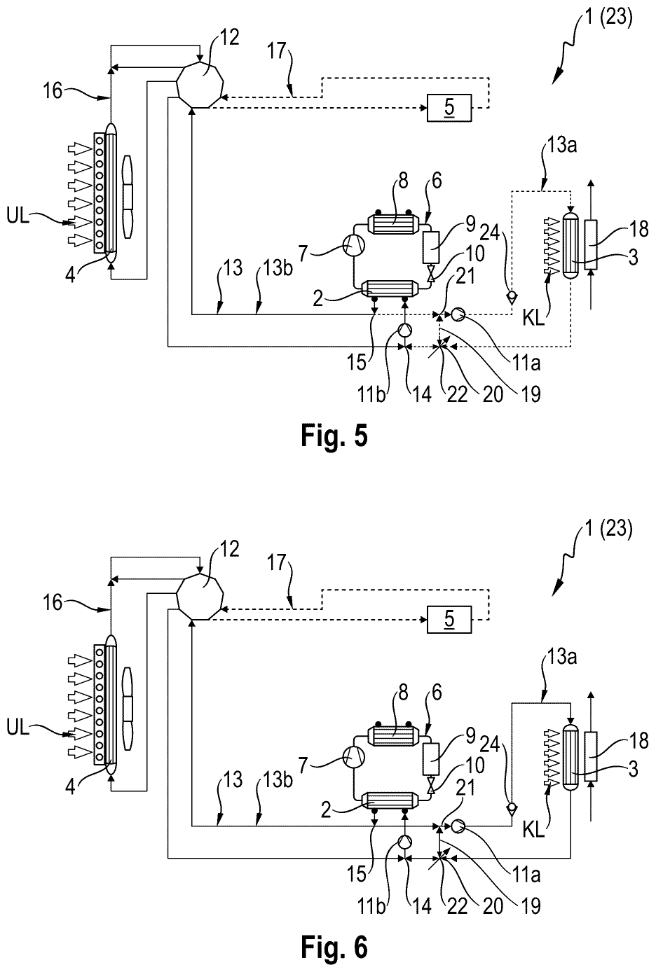

FIG. 5 shows the first embodiment of the system obtained with the invention in the cab-heating mode; and

FIG. 6 shows the first embodiment of the system obtained with the invention in the dehumidifying mode.

FIG. 1 shows a first embodiment of the cooling and/or heating system 1 obtained with the invention for a vehicle. The system 1 contains a chiller 2, a cab cooler 3, a low-temperature cooler 4, and a battery cooler 5. Air KL flowing into the cab can flow through the cab cooler 3, and outside air UL can flow through the low-temperature cooler 4. The battery cooler is designed such that it can be connected to a vehicle battery for heat exchange.

The chiller 2 is connected to a refrigerant circuit 6. A compressor 7, condenser 8, reservoir/dryer 9, and expansion valve 10 can also be connected to the refrigerant circuit 6. The system 1 also has a first pump 11a and second pump 11b, as well as a distributor valve 12. The distributor valve 12 can be a unit containing numerous valves. The chiller 2, cab cooler 3 and pumps 11a, 11b are connected to a coolant circuit 13.

This coolant circuit 13 contains a first subsidiary circuit 13a and second subsidiary circuit 13b. The chiller 2 and cab cooler 3 are connected in series to the first subsidiary circuit 13a. The chiller 2 and distributor valve 12 are connected in series to the second subsidiary circuit 13b. The chiller 2 is thus connected to both subsidiary circuits 13a, 13b. A check valve 24 is also connected to the first subsidiary circuit 13, which prevents backflow of the coolant.

The subsidiary circuits 13a, 13b join at a connecting point 14, and separate at a separating point 15. The circuit connecting point 14 is downstream of the cab cooler 3 and upstream of the chiller 2, and the separating point 15 is downstream of the chiller 2 and upstream of the distributor valve 12 and cab cooler 3. The chiller 2 is in a section between the connecting point 14 and the separating point 15, which is the only section through which coolant flows through both subsidiary circuits 13a and 13b. The first pump 11a is downstream of the separating point 15 and upstream of the cab cooler 3 in the first subsidiary circuit 13a. The second pump 11b is downstream of the connecting point 14 and upstream of the chiller 2 in the coolant circuit 13. Consequently, the second pump 11b is connected to both subsidiary circuits 13a, 13b.

The low-temperature cooler 4 and distributor valve 12 are connected in series to a radiator coolant circuit 16. The battery cooler 5 and distributor valve 12 are connected in series to a battery coolant circuit 17. The distributor valve 12 is also connected to the second subsidiary circuit 13b such that the second subsidiary circuit 13b can be connected to the radiator circuit 16 and/or the battery circuit 17.

There is also a heater 18 in FIG. 1, through which the air KL can flow into the cab. The heater 18 is downstream of the cab cooler 3 in relation to the air KL flowing into the cab. The heater 18 is not part of the system 1 obtained with the invention, but it can be connected to a heating circuit through which coolant flows. The heating circuit can be connected to the refrigerant circuit 6 by the condenser 8 for heat exchange.

The system 1 also has a bypass 19 controlled by a three-way valve 20. The bypass 19 is connected to the first subsidiary circuit 13a at a bypass connecting point 21 and a bypass separating point 22. The bypass connecting point 21 is downstream of the circuit separating point 15 and upstream of the first pump 11a and the cab cooler 3. The bypass separating point 22 is upstream of the circuit connecting point 14 and downstream of the first pump 11a and the cab cooler 3. The three-way valve 20 connected to the first subsidiary circuit 13a at the bypass separating point 22. The three-way valve 20 can open or close the bypass 19, partially or entirely.

FIG. 2 shows a second embodiment of the system 1 obtained with the invention. In this case, the second pump 11b is downstream of the circuit separating point 15 and upstream of the distributor valve 12 in the second subsidiary circuit 13b. Otherwise, the two embodiments are the same.

FIG. 3 shows the first embodiment of the system 1 obtained with the invention executing the method 23 obtained with the invention in a cab-cooling mode. The air KL in the cab is cooled by the cab cooler 3 in this mode. The three-way valve 20 is set for this such that the bypass 19 is closed. All of the coolant flows from the bypass separating point 22 in the first subsidiary circuit 13 to the circuit connecting point 14 and from there to the chiller 2. The coolant is cooled in the chiller 2, and flows entirely from the circuit separating point 15 in the first subsidiary circuit 13a and from there to the cab cooler 3. The air KL is cooled in the cab cooler 3, and flows from there in the cab. The temperature of the coolant exiting the chiller 2 can be between −2° C. and 12° C., and between 2° C. and 15° C. when exiting the cab cooler 3. This temperature can be set as needed to cool the cab. No coolant flows through the second subsidiary circuit 13b to the battery cooler 5 and/or low-temperature cooler 4. The first and/or second pump 11a, 11b can be switched on to convey coolant in the first subsidiary circuit 13a. The system 1 can be operated in the cab cooling mode when the outside temperature is between 10° C. and 50° C.

FIG. 4 shows the first embodiment of the system 1 obtained with the invention executing the method 23 obtained with the invention in a cab/battery-cooling mode. The bypass 19 is closed by the three-way valve 20 in this mode. All of the coolant flows out of the first subsidiary circuit 13a from the bypass separating point 22 to the circuit connecting point 14. The coolant in the first and second subsidiary circuits 13a, 13b flows together at the circuit connecting point 14, and then to the chiller 2. The coolant is cooled by the refrigerant in the chiller 2 and flows from the circuit separating point 15 in both subsidiary circuits 13a and 13b. The coolant can then cool the air KL in the cab with the cab cooler 3 in the first subsidiary circuit 13a, and cool the battery with the battery cooler 5 in the second subsidiary circuit 13b. In this case, the distributor valve 12 is set in the second subsidiary circuit 13b such that coolant flows through the battery cooler 5, but no coolant flows through the low-temperature cooler 4. The temperature of the coolant exiting the chiller can be between −2° C. and 12° C., and between 2° C. and 15° C. when exiting the cab cooler 3. The temperature of the coolant can be set as needed to cool the cab. The first and/or second pump 11a, 11b can be switched on to obtain the desired temperature and/or volumetric flow of coolant in the subsidiary circuits 13a, 13b. The system 1 can be operated in the cab/battery-cooling mode when the outside temperature is between 10° C. and 50° C.

FIG. 5 shows the first embodiment of the system 1 obtained with the invention executing the method 23 obtained with the invention in a cab-heating mode. The first pump 11a is switched off and no coolant flows through the first subsidiary circuit 13a in this mode. Consequently, coolant does not flow through the cab cooler 3 in the first subsidiary circuit 13a, and the air KL is not cooled. The air KL in the cab can be heated externally, or in an external heat exchanger 18, to the desired temperature. The second pump 11b is switched on, and coolant flows through the second subsidiary circuit 13b. The coolant in the second subsidiary circuit 13b is cooled to below the outside temperature by the refrigerant in the chiller 2 and then heated in the low-temperature cooler 4 by the outside air. The low-temperature cooler 4 is therefore used here as a heat source for a heat pump. For this, the distributor valve 12 is set in the second subsidiary circuit 13b such that no coolant flows through the battery cooler 5, but instead, only flows through the low-temperature cooler 4. The temperature of the coolant exiting the chiller 2 can be between −30° C. and 15° C. The temperature of the coolant can be set as needed for the heat pump. The system 1 can be operated in the cab-heating mode when the outside temperature is between −40° C. and 25° C.

FIG. 6 shows the first embodiment of the system 1 obtained with the invention executing the method 23 obtained with the invention in a dehumidifying mode. The three-way valve 20 is set in this mode such that at least part of the coolant in the first subsidiary circuit 13a can flow through the bypass 19. This coolant is then conveyed to the cab cooler 3 without additional cooling in the chiller 2. The amount of coolant flowing through the bypass 19 can be adjusted to control and regulate the temperature of the coolant in the first subsidiary circuit 13a. The temperature of the coolant in the first subsidiary circuit 13a can be between 2° C. and 25°, for example, to prevent the cab cooler 3 from icing up. The air KL can be cooled in the cab cooler 3 to dehumidify it. This air KL can then be heated to the desired temperature in an external heat exchanger 18. Dehumidifying this air KL keeps the windows in the vehicle from frosting over. The coolant flows through the chiller 2 in the second subsidiary circuit 13b and can be cooled. The coolant can then absorb heat from the outside air UL in the low-temperature cooler 4. The temperature of the coolant in the second subsidiary circuit 13b can be between −30° C. and 15° C. The system 1 can be operated in the dehumidifying mode when the outside temperature is between 0° C. and 25° C.

The specification can be readily understood with reference to the following Numbered Paragraphs:

Numbered Paragraph 1. A cooling and/or heating system (1) for a vehicle, wherein
the system (1) contains a chiller (2), a distributor valve (12), and a cab cooler (3) through which air (KL) flowing into the cab can flow,
the chiller (2) is connected to a refrigerant circuit (6) in the system (1),
the cab cooler (3), distributor valve (12), and chiller (2) are connected to a coolant circuit (13) in the system (1),
the coolant circuit (13) has a first subsidiary circuit (13a) to which the chiller (2) and cab cooler (3) are connected, and a second subsidiary circuit (13b) to which the chiller (2) and the distributor valve (12) are connected,
the first subsidiary circuit (13a) and second subsidiary circuit (13b) in the coolant circuit (13) separate at a separating point (15) and rejoin at a connecting point (14),
the circuit separating point (15) is downstream of the chiller (2) and upstream of the cab cooler (3) and the distributor valve (12), and the circuit connecting point (14) is upstream of the chiller (2) and downstream of the cab cooler (3) and the distributor valve (12),
the system (1) has a bypass (19) that is connected to the first subsidiary circuit (13a) in the coolant circuit (13) at a bypass connecting point (21) and a bypass separating point (22), and
the bypass connecting point (21) is downstream of the circuit separating point (15) and upstream of the cab cooler (3), and the bypass separating point (22) is downstream of the cab cooler (3) and upstream of the circuit connecting point (14).

Numbered Paragraph 2. The system (1) according to Numbered Paragraph 1, characterized in that the system (1) contains a first pump (11a), which is downstream of the bypass connecting point (21) and upstream of the bypass separating point (22) in the first subsidiary circuit (13a) in the coolant circuit (13).

Numbered Paragraph 3. the System (1) According to Numbered Paragraph 1 or 2, characterized in that
the system (1) contains a second pump (11b) that is downstream of the circuit separating point (15) and upstream of the circuit connecting point (14) in the second subsidiary circuit (13b) in the coolant circuit (13), or
the system (1) contains a second pump (11b) that is downstream of the circuit connecting point (14) and upstream of the chiller (2) in the second subsidiary circuit (13b) in the coolant circuit (13).

Numbered Paragraph 4. The system (1) according to any of the preceding Numbered Paragraphs, characterized in that
the system (1) contains a three-way valve (20) that is connected to the first subsidiary circuit (13a) in the coolant circuit (13) at the bypass separating point (22), and
the three-way valve (20) can be set to allow or prevent coolant from flowing through the bypass (19).

Numbered Paragraph 5. The system (1) according to any of the preceding Numbered Paragraphs, characterized in that
the system (1) has a low-temperature cooler (4) through which outside air can flow,
the low-temperature cooler (4) and distributor valve (12) are connected to a radiator coolant circuit (16), and
the distributor valve (12) can be set to connect the radiator circuit (16) to the second subsidiary circuit (13b) in the coolant circuit (13), such that coolant flows successively through the chiller (2) and the low-temperature cooler (4).

Numbered Paragraph 6. The system (1) according to any of the preceding Numbered Paragraphs, characterized in that
the system (1) contains a battery cooler (5) that can be connected to a vehicle battery for heat exchange,
the battery cooler (5) and distributor valve (12) are connected to a battery coolant circuit (17),
the distributor valve (12) can be set to connect the battery circuit (17) to the second subsidiary circuit (13b) in the coolant circuit (13), such that coolant can flow successively through the chiller (2) and the battery cooler (5).

Numbered Paragraph 7. The system (1) according to Numbered Paragraphs 5 and 6, characterized in that the distributor valve (12) can be set such that the battery circuit (17) and/or radiator circuit (16) are connected to or separated from the second subsidiary circuit (13b) in the coolant circuit (13).

Numbered Paragraph 8. A method (23) for operating the system (1) according to any of the preceding Numbered Paragraphs, wherein the bypass (19) in the system (1) is regulated based on the temperature of the coolant to be set in the first subsidiary circuit (13a) of the coolant circuit (13) and/or the temperature of the coolant to be set in the second subsidiary circuit (13b) of the coolant circuit (13).

Numbered Paragraph 9. the Method (23) According to Numbered Paragraph 8, characterized in that
the system (1) has a first pump (11a) and second pump (11b) connected to the coolant circuit (13),
the first pump (11a) and second pump (11b) are operated in the method such that coolant does or does not flow through the first and/or second subsidiary circuits (13a, 13b) in the coolant circuit (13),
the system (1) has a low-temperature cooler (4) and a battery cooler (5),
the system (1) has a battery coolant circuit (17) to which the battery cooler (5) and distributor valve (12) are connected, and a radiator coolant circuit (16) to which the low-temperature cooler (4) and the distributor valve (12) are connected, and
the distributor valve (12) is switched in the method (23) to connect or separate the radiator circuit (16) and/or battery circuit (17) in the system (1) to or from the second subsidiary circuit (13b) in the coolant circuit (13).

Numbered Paragraph 10. The method (23) according to Numbered 9, characterized in that the system (23) is operated in a cab-cooling mode to cool air (KL) flowing into the cab, wherein
coolant flows through the first subsidiary circuit (13a) in the coolant circuit (13) in the system (1), and
no coolant flows through the second subsidiary circuit (13b) in the coolant circuit (13) and the bypass (19) in the system (1).

Numbered Paragraph 11. The method (23) according to Numbered Paragraph 9 or 10, characterized in that the system (1) is operated in a battery/cab-cooling mode to cool the air (KL) flowing into the vehicle cab, and to cool a vehicle battery, wherein
coolant flows through the first subsidiary circuit (13a) and the second subsidiary circuit (13b) in the coolant circuit (13) in the system (1)
the battery circuit (17) in the system (1) is connected to the second subsidiary circuit (13b) in the coolant circuit (13) in the system (1), and coolant flows through it,
the radiator circuit (16) in the system (1) is not connected to the second subsidiary circuit (13b) in the coolant circuit (13) in the system (1), and no coolant flows through it, and
no coolant flows through the bypass (19) in the system (1).

Numbered Paragraph 12. The method (23) according to any of the Numbered Paragraphs 9 to 11, characterized in that the system (1) is operated in a cab-heating mode to heat the air (KL) in the cab, wherein
coolant flows through the second subsidiary circuit (13b) in the coolant circuit (13) in the system (1),
the battery circuit (17) in the system (1) is not connected to the second subsidiary circuit (13b) in the coolant circuit (13) in the system (1), and no coolant flows through it,
the radiator circuit (16) in the system (1) is connected to the second subsidiary circuit (13b) in the coolant circuit (13) in the system (1), and coolant flows through it, and
no coolant flows through the first subsidiary circuit (13a) in the coolant circuit (13) or the bypass (19) in the system (1).

Numbered Paragraph 13. The method (23) according to any of the Numbered Paragraphs 9 to 11, characterized in that the system (1) is operated in a dehumidifying mode to dehumidify the air (KL) in the vehicle cab, wherein
coolant flows through the first subsidiary circuit (13a) and the second subsidiary circuit (13b) in the coolant circuit (13) and the bypass (19) in the system (1),
the battery circuit (17) in the system (1) is not connected to the second subsidiary circuit (13b) in the coolant circuit (13) in the system (1), and no coolant flows through it, and
the radiator circuit (16) in the system (1) is connected to the second subsidiary circuit (13b) in the coolant circuit (13) in the system (1), and coolant flows through it.

Numbered Paragraph 14. The method (23) according to Numbered Paragraph 13, characterized in that
at least part of the coolant flowing in the first subsidiary circuit (13a) is returned to the first subsidiary circuit through the bypass (19) at the bypass separating point (22) in the dehumidifying mode, and
the temperature of the coolant in the first subsidiary circuit (13a) is kept above 0° C.

Numbered Paragraph 15. The method (23) according to any of the Numbered Paragraphs 8 to 14, characterized in that
the system (1) is operated in the cab-cooling mode when the outside temperature is between 10° C. and 50° C., and/or
the system (1) is operated in the cab/battery-cooling mode when the outside temperature is between 10° C. and 50° C., and/or
the system (1) is operated in the cab-heating mode when the outside temperature is between −40° C. and 25° C., and/or
the system (1) is operated in the dehumidifying mode when the outside temperature is between 0° C. and 25° C.

### LIST OF REFERENCE SYMBOLS

1 system
2 chiller
3 cab cooler
4 low-temperature cooler
5 battery cooler
6 refrigerant circuit
7 compressor
8 condenser
9 reservoir/dryer unit
10 expansion valve
11a/11b first/second pump
12 distributor valve
13 coolant circuit
13a/13b first/second subsidiary circuit
14 circuit connecting point
15 circuit separating point
16 radiator circuit
17 battery circuit
18 heater
19 bypass
20 three-way valve
21 bypass connecting point
22 bypass separating point
23 method
24 check valve
KL air in the cab
UL outside air

1-15. (canceled)

16. A cooling and/or heating system for a vehicle, comprising
a chiller, a distributor valve, and a cab cooler through which air flowing into the cab can flow,
the chiller is connected to a refrigerant circuit in the system,
the cab cooler, distributor valve, and chiller are connected to a coolant circuit in the system,
the coolant circuit comprises a first subsidiary circuit to which the chiller and cab cooler are connected, and a second subsidiary circuit to which the chiller and the distributor valve are connected,
the first subsidiary circuit and second subsidiary circuit in the coolant circuit separate at a separating point and rejoin at a connecting point,
the circuit separating point is downstream of the chiller and upstream of the cab cooler and the distributor valve, and the circuit connecting point is upstream of the chiller and downstream of the cab cooler and the distributor valve,
the system further comprises a bypass that is connected to the first subsidiary circuit in the coolant circuit at a bypass connecting point and a bypass separating point, and
the bypass connecting point is downstream of the circuit separating point and upstream of the cab cooler, and the bypass separating point is downstream of the cab cooler and upstream of the circuit connecting point.

17. The system according to claim 16, further comprising a first pump, which is downstream of the bypass connecting point and upstream of the bypass separating point in the first subsidiary circuit in the coolant circuit.

18. The system according to claim 16, further comprising
a second pump that is downstream of the circuit separating point and upstream of the circuit connecting point in the second subsidiary circuit in the coolant circuit, or
a second pump that is downstream of the circuit connecting point and upstream of the chiller in the second subsidiary circuit in the coolant circuit.

19. The system according to claim 16, further comprising a three-way valve that is connected to the first subsidiary circuit in the coolant circuit at the bypass separating point, wherein the three-way valve can be set to allow or prevent coolant from flowing through the bypass.

20. The system according to claim 16, further comprising a low-temperature cooler through which outside air can flow, wherein the low-temperature cooler and distributor valve are connected to a radiator coolant circuit, and
the distributor valve is configured to be set to connect the radiator circuit to the second subsidiary circuit in the coolant circuit, such that coolant flows successively through the chiller and the low-temperature cooler.

21. The system according to claim 16, further comprising a battery cooler that is configured to be connected to a vehicle battery for heat exchange, wherein the battery cooler and distributor valve are connected to a battery coolant circuit, and the distributor valve is configured to be set to connect the battery circuit to the second subsidiary circuit in the coolant circuit, such that coolant can flow successively through the chiller and the battery cooler.

22. The system according to claim 20, wherein the distributor valve is configured to be set such that the battery circuit and/or radiator circuit are connected to or separated from the second subsidiary circuit in the coolant circuit.

23. A method for operating the system according to claim 16, regulating the bypass in the system based on a temperature of the coolant to be set in the first subsidiary circuit of the coolant circuit and/or a temperature of the coolant to be set in the second subsidiary circuit of the coolant circuit.

24. The method according to claim 23, wherein
the system further comprises a first pump and second pump connected to the coolant circuit,
further comprising operating the first pump and second pump such that coolant does or does not flow through the first and/or second subsidiary circuits in the coolant circuit,
the system further comprises a low-temperature cooler and a battery cooler, a battery coolant circuit to which the battery cooler and distributor valve are connected, and a radiator coolant circuit to which the low-temperature cooler and the distributor valve are connected, and
switching the distributor valve to connect or separate the radiator circuit and/or battery circuit to or from the second subsidiary circuit in the coolant circuit.

25. The method according to claim 24, further comprising operating the system in a cab-cooling mode to cool air flowing into the cab, wherein
coolant flows through the first subsidiary circuit in the coolant circuit, and
no coolant flows through the second subsidiary circuit in the coolant circuit and the bypass.

26. The method according to claim 24, further comprising operating the system in a battery/cab-cooling mode to cool the air flowing into the vehicle cab, and to cool a vehicle battery, wherein
coolant flows through the first subsidiary circuit and the second subsidiary circuit in the coolant circuit,
wherein the battery circuit is connected to the second subsidiary circuit in the coolant circuit, and coolant flows through the second subsidiary circuit,
the radiator circuit in the system is not connected to the second subsidiary circuit in the coolant circuit in the system, and no coolant flows through second subsidiary circuit, and
no coolant flows through the bypass.

27. The method according to claim 24, further comprising operating the system in a cab-heating mode to heat the air in the cab, wherein
coolant flows through the second subsidiary circuit in the coolant,
the battery circuit is not connected to the second subsidiary circuit in the coolant circuit, and no coolant flows through the second subsidiary circuit,
the radiator circuit is connected to the second subsidiary circuit in the coolant circuit, and coolant flows through the second subsidiary circuit, and
no coolant flows through the first subsidiary circuit in the coolant circuit or the bypass.

28. The method according to claim 24, further comprising operating the system in a dehumidifying mode to dehumidify the air in the vehicle cab, wherein
coolant flows through the first subsidiary circuit and the second subsidiary circuit in the coolant circuit and the bypass,
the battery circuit is not connected to the second subsidiary circuit in the coolant circuit, and no coolant flows through the second subsidiary circuit, and
the radiator circuit is connected to the second subsidiary circuit in the coolant circuit in the system, and coolant flows through the second subsidiary circuit.

29. The method according to claim 28, wherein
at least part of the coolant flowing in the first subsidiary circuit is returned to the first subsidiary circuit through the bypass at the bypass separating point in the dehumidifying mode, and
the temperature of the coolant in the first subsidiary circuit is kept above 0° C.

30. The method according to claim 23, wherein
the system is operated in the cab-cooling mode when an outside temperature is between 10° C. and 50° C., and/or
the system is operated in the cab/battery-cooling mode when the outside temperature is between 10° C. and 50° C., and/or
the system is operated in the cab-heating mode when the outside temperature is between −40° C. and 25° C., and/or
the system is operated in the dehumidifying mode when the outside temperature is between 0° C. and 25° C.
